(19) United States
(12) Patent Application Publication
(10) Pub. No.: US 2006/0258448 A1
(43) Pub. Date: Nov. 16, 2006

(54) Storage medium storing game program, game apparatus and game controlling method

(75) Inventors: Hiroaki Ishibashi, Tokyo (JP); Fumihiro Kanaya, Tokyo (JP)

Correspondence Address: NIXON & VANDERHYE, PC, 901 NORTH GLEBE ROAD, 11TH FLOOR, ARLINGTON, VA, 22203, US

(73) Assignee: Nintendo Co., Ltd., Kyoto (JP)

(21) Appl. No.: 11/368,695

(22) Filed: Mar. 7, 2006

(30) Foreign Application Priority Data
May 16, 2005 (JP) 2005-143095

(51) Int. Cl. A63F 13/00

(52) U.S. Cl. 463/31

(57) ABSTRACT

A game apparatus includes a game machine and a game cartridge. During the game, when a player depresses an A button or a B button, gravity occurs on a player character. At this time, when a non-player character exists within a gravitational sphere, an attractive force or a repulsive force acts on the player character from the non-player character according to the operated button. Due to this, a moving direction and a moving velocity of the inertially moving player character are changed.

### CROSS REFERENCE OF RELATED APPLICATION

The disclosure of Japanese Patent Application No. 2005-143095 is incorporated herein by reference.

### BACKGROUND OF THE INVENTION

1. Field of the Invention

The present invention relates to a storage medium storing game program, a game apparatus, and a game controlling method. More specifically, the present invention relates to a storage medium storing game program, a game apparatus, and a game controlling method that allow a game play by displaying a virtual game space on a display means.

2. Description of the Related Art

Techniques has been known that in order to advance the game, a player controls an object or a character accepting inertia to some extent as well as directly controls a movement and a moving direction of the character through the operation of a game controller. For example, according to the game of the related art (“Super Mario Brothers URAWAZA TAIZENSYU BEKKAN” 20-th ed. published by Futami Shobo Publishing Co., Ltd. Mar., 12, 1986), a player character accepts downward inertia in the sea, and would fall (sink) if it was left without any operation. Accordingly, in order to advance the game stage, a player causes the player character to rise by application of buoyancy according to a button operation of the controller or the character to sink without any operation, and this enables the player character to avoid the enemy character, and to obtain an item.

However, in the game disclosed in the related art, the player can merely apply (move) a force reverse to a direction of the inertia by operating a button of the controller, and cannot enjoy playing the game by controlling the moving direction of the player character at his or her discretion.

### SUMMARY OF THE INVENTION

Therefore, it is a primary object of the present invention to provide a novel storage medium storing game program, a game apparatus, and game controlling method.

Another object of the present invention is to provide a storage medium storing game program, a game apparatus, and a game controlling method capable of obtaining a novel sense of operating.

A storage medium storing game program according to the present invention stores a game program of a game apparatus including an operation means, a storage means, and a display means. The game program causes a processor of the game apparatus to execute an operation input detecting step, a player character movement display step, a non-player character display step, a first moving direction calculating step, a second moving direction calculating step, and a player character moving step. The operation input detecting step detects at least first operation data and second operation data different from the first operation data to be input in response to an operation of the operation means. The player character movement display step movably displays on the display means a player character inertially moving on the basis of the operation data and player character data stored by the storage means. The non-player character display step displays a non-player character on the display means on the basis of the non-player character data which is stored in the storage means and is plural in number, and to which a different attribute is set. The first moving direction calculating step calculates a first direction in which the player character moves in association with the non-player character by making the player character work as the source of attraction according to the first operation data. The second moving direction calculating step calculates a second direction reverse to the first direction in which the player character moves in association with the non-player character by making the player character work as the source of repulsion according to the second operation data. The player character moving step moves the player character to the first direction calculated by the first moving direction calculating step or the second direction calculated by the second moving direction calculating step.

More specifically, the game program is executed by the game apparatus (10: a reference numeral corresponding in the “detailed description of preferred embodiment” described later and so forth). The game apparatus (10) is provided with an operation means (26, 28), a storage means (48, 60), and a display means (18). The operation input detecting step (42, S7) detects first operation data and second operation data to be input according to an operation of the operation means (26, 28). It is noted that the first operation data and the second operation data are different from each other. The player character movement display step (42, S3, S5, S13) movably displays on the display means (18) a player character inertially moving on the basis of the operation data and player character data (604a, 484a) stored by the storage means (48, 60). It is noted that as described later, the player character may be changed in the moving direction, but even in such a case, the player character continues to inertially move. Also, the non-player character display step (42, S3, S5) statically displays a non-player character on the display means (18) on the basis of the non-player character data (604a, 486, 488, . . . ) which is stored in the storage means (48, 60) and is plural in number, and to which a different attribute is set. The first direction calculating step (42, S11) calculates a first direction in which the player character moves in association with the non-player character by making the player character work as the source of attraction according to the first operation data (operation data indicated by a reference numeral of 26). Also, the second direction calculating step (42, S11) calculates a second direction reverse to the second direction in which the player character moves in association with the non-player character by making the player character work as the source of repulsion according to the second operation data (operation data indicated by a reference numeral 28). The first direction and the second direction are reverse to each other. The player character moving step (42, S13) moves the player character in the first direction or the second direction.

According to the present invention, the player character is moved to a moving direction changeable depending on an attractive force or a repulsive force applied by the non-player character operation means in response to an operation by the operating means, and whereby, the game is advanced, allows a player to feel a new sense of operating.

In one aspect of the present invention, the game program, when the player character and any one of the non-player characters have a predetermined positional relationship, and a first attribute of the player character and a second attribute of the non-player character satisfy a predetermined condition, further causes the processor to execute a first attribute updating step for updating the first attribute. More specifically, the first attribute updating step (42, S25), when the player character and any one of the non-player characters have a predetermined positional relationship (within the constant distance L), and a first attribute of the player character and a second attribute of the non-player character satisfy a predetermined condition, updates the first attribute. That is, the attribute of the player character is changed on the basis of the non-player character having a predetermined positional relationship with the player character, which provides a change in the progress of the game, allowing the player to enjoy playing the game.

In one embodiment of the present invention, the game program causes the processor to execute a second attribute updating step for updating the second attribute according to the first attribute updated by the first attribute updating step. More specifically, the second attribute updating step (42, S27) updates the second attribute according to the first attribute updated by the first attribute updating step (42, S25). That is, when the attribute of the player character is changed, the attribute of the non-player character is also changed. Accordingly, it is possible to enjoy the change of the attribute of the non-player character as well as the change of the attribute of the player character.

In another embodiment of the present invention, the first attribute includes at least a size of the player character, the second attribute includes at least a size of the non-player character, the first attribute updating step updates the first attribute such that the player character is increased in size when the player character is larger than the non-player character which has a predetermined positional relationship with the player character. More specifically, the first attribute includes at least a size of the player character, and the second attribute includes at least a size of the non-player character. The first attribute updating step (42, S25) updates the first attribute such that the player character is increased in size when the player character is larger than the non-player character which has a predetermined positional relationship with the player character. That is, the player character is grown. This makes it possible to enjoy a process of the growth of the player character.

In another embodiment of the present invention, the game program causes the processor to further execute a non-player character disappearance step for making the non-player character having the predetermined positional relationship with the player character disappear when the first attribute updating step increase the player character in size. More specifically, the non-player character disappearance step (42, S29), when the first attribute updating step (42, S25) increase the player character in size, that is, when the player character grows, makes the non-player character having a predetermined positional relationship with the player character disappear. That is, it is erased from the display means (18). Thus, when the player character grows, the non-player character disappears, it is possible to produce as if the non-player character is swallowed by the player character.

In the other embodiment of the present invention, the game program causes the processor to further execute a player character disappearance step for making the player character disappear when the player character is smaller than the non-player character which has the predetermined positional relationship with the player character. More specifically, the player character disappearance step (42, S43) makes the player character disappear when the player character is smaller than the non-player character which has the predetermined positional relationship with the player character. That is, the player character dies. That is, the rest of the number of the player characters is decreased, or the game is over. Thus, the player character may die, so that the player can enjoy operating the player character, considering a strategy for movement of the player character.

In another embodiment of the present invention, the game program causes the processor to further execute a game clear determination step for determining to be a game clear when the second attribute of the non-player character having a predetermined positional relationship with the player character indicates a specific property. More specifically, the game clear determination step (42, S37) determines to be a game clear when the second attribute of the non-player character having a predetermined positional relationship with the player character indicates a specific property (YES” in S37). Thus, it is determined to be a game clear when the player character has the predetermined positional relationship with a specific non-player character, so that the player can enjoy playing the game, feeling a necessity of new strategy.

In another aspect of the present invention, the first direction calculating step calculates a moving direction of the player character such that the moving direction of the player character is gradually converged into a first direction toward a position of any one of the non-player characters, and the second direction calculating step calculates a moving direction of the player character such that the moving direction of the player character is gradually converged into a second direction away from a position of any one of the non-player characters. More specifically, first direction calculating step (42, S11) calculates a moving direction of the player character such that the moving direction of the player character is gradually converged into a first direction toward a position of any one of the non-player characters. The second direction calculating step (42, S11) calculates a moving direction of the player character such that the moving direction of the player character is gradually converged into a second direction away from a position of any one of the non-player characters. Thus, it is possible to gradually change the direction without a sharp change of the moving direction, allowing the player to obtain an operating environment in which he or she can make fine adjustments of the moving direction.

The game apparatus according to the present invention is provided with an operation means, a storage means, and a display means. The game apparatus further includes an operation input detecting means, a player character movement display means, a non-player character display means, a first moving direction calculating means, a second moving direction calculating means, and a player character moving means. The operation input detecting means detects at least first operation data and second operation data different from the first operation data to be input in response to an operation of the operation means. The player character movement display means movably displays on the display means a player character inertially moving on the basis of the operation data and the player character data stored by the storage means. The non-player character display means displays a non-player character on the display means on the basis of non-player character data which is stored in the storage means and is plural in number, and to which a different attribute is set. The first moving direction calculating means calculates a first direction in which the player character moves in association with the non-player character by making the player character work as the source of attraction according to the first operation data. The second moving direction calculating means calculating a second direction reverse to the first direction in which the player character moves in association with the non-player character by making the player character work as the source of repulsion according to the second operation data. The player character moving means moves the player character to the first direction calculated by the first moving direction calculating means or the second direction calculated by the second moving direction calculating means.

Also in the invention of the game apparatus, it is possible to provide a novel sense of operating similar to the above-described invention of the storage medium storing game program.

A game controlling method according to the present invention is a game controlling method of the game apparatus including an operation means, a storage means, and a display means. The game controlling method includes following steps of: (a) detecting at least first operation data and second operation data different from the first operation data to be input in response to an operation of the operation means, (b) movably displaying on the display means a player character inertially moving on the basis of the operation data and player character data stored by the storage means, (c) displaying a non-player character on the display means on the basis of non-player character data which is stored in the storage means and is plural in number, and to which a different attribute is set, (d) calculating a first direction in which the player character moves in association with the non-player character by making the player character work as the source of attraction according to the first operation data, (e) calculating a second direction reverse to the first direction in which the player character moves in association with the non-player character by making the player character work as the source of repulsion according to the second operation data, and (f) moving the player character to the first direction calculated by the step (d) or the second direction calculated by the step (e).

In the invention of the game controlling method, it is possible to provide a novel sense of operating similar to the above-described invention of the storage medium storing game program.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing a game apparatus of one embodiment of the present invention;

FIG. 2 is a block diagram showing an electric configuration of a game apparatus of FIG. 1 embodiment;

FIG. 3 is an illustrative view showing one example of a game screen to be displayed on an LCD shown in FIG. 1 embodiment;

FIG. 4 is an illustrative view showing another example of a game screen to be displayed on the LCD shown in FIG. 1 embodiment;

FIG. 5 is an illustrative view the other example of a game screen to be displayed on the LCD shown in FIG. 1 embodiment;

FIG. 6 is an illustrative view for explaining a property of a player character of FIG. 1 embodiment;

FIG. 7 is an illustrative view for explaining a shifting state of the moving trace of a player character by an attractive force and a repulsive force acting on the player character in FIG. 1 embodiment;

FIG. 8 is an illustrative view for explaining changes of strength of an attractive force and a repulsive force depending on distance or/and size a player character and a non-player character in FIG. 1 embodiment;

FIG. 9 is an illustrative view showing an example of a case that a plurality of non-player characters exist within a gravitational sphere of the player character in FIG. 1 embodiment;

FIG. 10 is an illustrative view showing an example of a memory map of a ROM provided in a game cartridge shown in FIG. 1 embodiment;

FIG. 11 is an illustrative view showing an example of a memory map of a WRAM shown in FIG. 2;

FIG. 12 is a flowchart showing a part of a game process of a CPU core shown in FIG. 2;

FIG. 13 is a flowchart showing an example of another part of the game process of the CPU core shown in FIG. 2, and continues from FIG. 12;

FIG. 14 is a flowchart showing a further part of the game process of the CPU core shown in FIG. 2, and continues from FIG. 12 and FIG. 13; and

FIG. 15 is an illustrative view showing another embodiment of the present invention, and describing another calculation method in a case that a moving direction of the player character is changed.

### DETAILED DESCRIPTION OF THE PREFERRED EMBODIMENTS

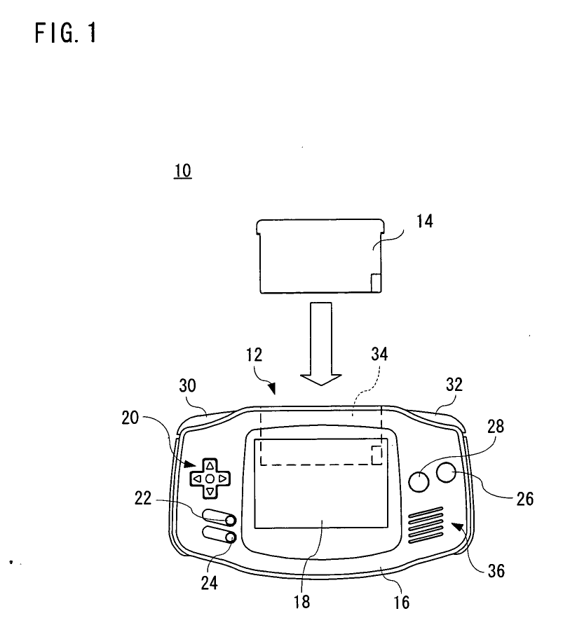

Referring to FIG. 1, a game apparatus 10 of one embodiment of the present invention includes a game machine 12 and a game cartridge 14. As such the game machine 12, a hand-held type game machine (product name “GAMEBOY ADVANCE”) produced and sold by an applicant of the present invention is applicable, and includes a housing 16. On the front surface of the housing 16 is provided a color liquid crystal display (hereinafter, referred to as “LCD”) 18 at an approximately center. On the LCD 18, a virtual game space and game characters appearing in the game space are displayed, and a message is also displayed as necessary. Also on the surface of the housing 16, operating buttons 20, 22, 24, 26, 28, 30, and 32 are provided. The operating buttons 20, 22 and 24 are placed at the left of the LCD 18, and the operating buttons 26 and 28 are placed at the right of the LCD 18. Furthermore, the operating buttons 30 and 32 are placed at an upper end surface (top surface) of the housing 16 (above the LCD 18).

The operating button 20 is a cross button which functions as a digital joystick, and is able to instruct a moving direction of the game characters displayed on the LCD 18 and move a cursor by operating any one of four depression portions. The operating button 22 is a start button formed by a push button, and utilized for instructing a start of the game, etc. The operating button 24 is a select button formed by the push button, and utilized for selecting a game mode, etc.

The operating button 26 is an A button formed by the push button, and allows the game character displayed on the LCD 18 to perform an arbitrary action such as hitting, throwing, holding, riding, jumping, etc. The operating button 28 is a B button formed by the push button, and utilized for changing to a game mode selected by the select button 24, canceling the action determined by the A button 26, and so forth. The operating button 30 is a left depression button (L button) formed by the push button, and the operating button 32 is a right depression button (R button) formed by the push button. The operating buttons 30 and 32 can perform the same operation as the A button 26 and the B button 28, and also function as a subsidiary of the A button 26 and the B button 28.

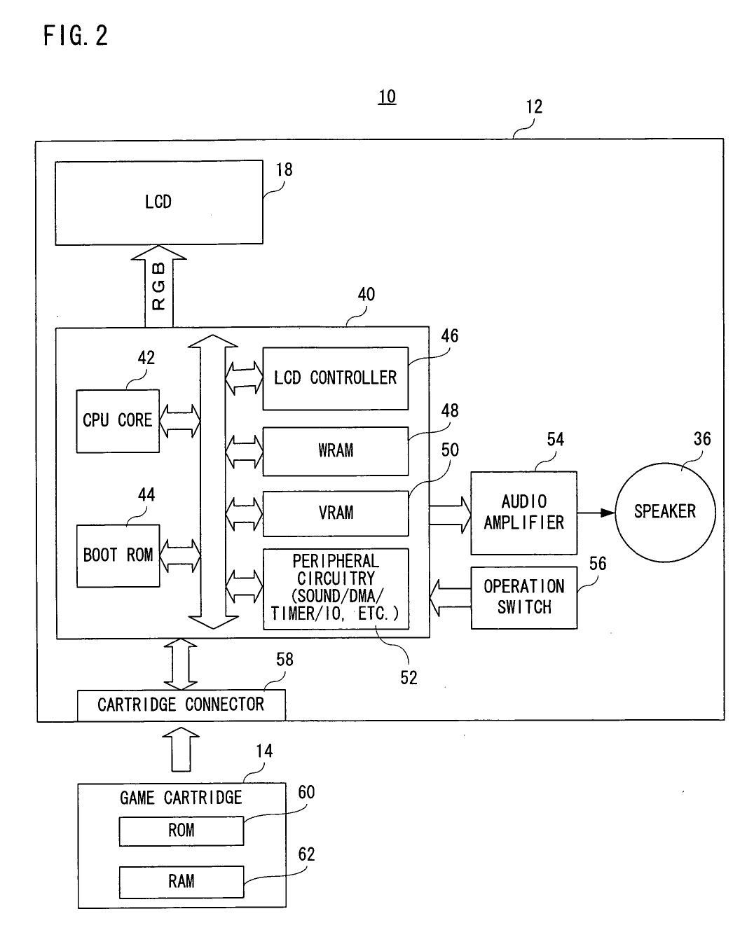

Also, on the rear surface of the housing 16 at an upper end, a loading slot 34 is provided. Into the loading slot 34, a game cartridge 14 is loaded. Although not illustrated, connectors are respectively provided at a depth portion of the loading slot 34 and at an end portion of the game cartridge 14 in the loading direction, and when the game cartridge 14 is loaded into the loading slot 34, the two connectors are connected with each other. Therefore, the game cartridge 14 is accessible by a CPU core 42 of the game machine 12 (see FIG. 2).

Furthermore, on the surface of the housing 16 below the A button 26 and the B button 28, a speaker 36 for outputting a BGM, a sound effect, a sound such as voices or onomatopoeic sound of the game character during the game, and so on is provided.

It is noted that although not illustrated, the housing 16 is provided with an external expansion connector on its upper surface, a battery accommodating box on its rear surface, and a power switch, a sound level volume, an earphone jack, etc. on its bottom surface.

FIG. 2 is a block diagram showing an electric configuration of the game apparatus 10. With referring to FIG. 2, the game machine 12 includes a processor 40, and the processor 40 includes the CPU core 42, and includes a boot ROM 44, an LCD controller 46, a WRAM (working RAM: and so forth) 48, a VRAM 50, and a peripheral circuitry 52 in relation to the CPU core 42. It is noted that the peripheral circuitry 52 includes a sound circuit, a DMA (Direct Memory Access) circuit, a timer circuit, an input-output interface (10), etc.

The processor 40 applies a display signal, that is, an RGB signal in this embodiment to the LCD 18 provided on a front surface of the game machine 12 as described above to allow the LCD 18 to color-display a game image. Also the processor 40 applies an audio signal to the sound circuit, and amplifies the audio signal in an audio amplifier 54 to allow the speaker 36 to output a voice (sound) such as game music and a sound effect. The respective operation buttons 20, 22, 24, 26, 28, 30 and 32 provided on the game machine 12 are represented as an operation switch 56 in a single unit. An operation signal from the operation switch 56 is input to the processor 40. Thus, the processor 40 executes a process according to an instruction applied from the operation switch 56.

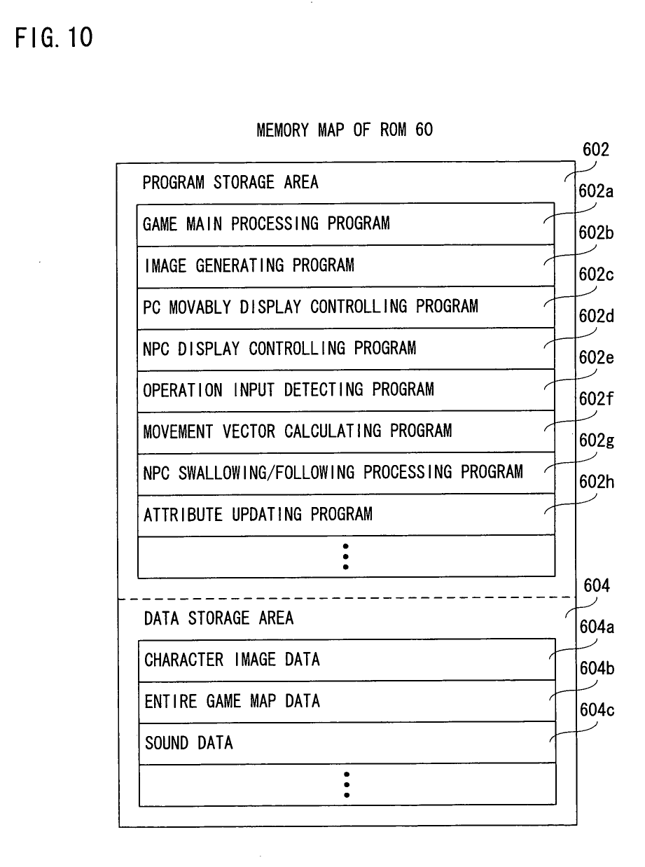

In addition, the game machine 12 has a cartridge connector 58 into which the game cartridge 14 is connected or inserted. The game cartridge 14 is integrated with a ROM 60 and a RAM (backup RAM) 62. The ROM 60 preliminary sets (stores) a game program of the game (virtual game) to be executed by game machine 12 and a game image (including character image) data, etc. (see FIG. 10). The RAM 62 stores (saves) proceeding data of the game and result data of the game.

When a power supply of the game machine 12 is turned on, the CPU core 42 executes a boot program stored in the boot ROM 44 to perform a start-up process of the game machine 12. Then, the CPU core 42 executes the game program stored in the ROM 60 of the game cartridge 14, and performs a game process while storing temporary data now being executed in the WRAM 48. Also, the image data generated through the execution of the game program by the CPU core 42 is stored in the VRAM 50, and the image data stored in the VRAM 50 is output to the LCD 18 by the LCD controller 46.

In the game apparatus 10 with such a configuration, a virtual game (action game) to be described below is playable. For example, the player operates the A button 26 or the B button 28 provided on the game machine 12 to thereby cause the player character PC to function as the source of attraction or the source of repulsion, and the movement of the player character PC is controlled by being affected by an attractive force or a repulsive force from the non-player character NPC. More specifically, at least one of a moving direction (angle) and velocity of the inertially moving player character is changed depending on an attractive force or a repulsive force with the non-player character NPC. Then, the player character PC earns points by swallowing or making the non-player character NPC follow itself. When the player character PC swallows the non-player character NPC, the size (attribute) thereof is increased, and accordingly, the attribute of the non-player character is also changed.

Here, the attribute of the non-player character roughly includes two states such as a state A of not being swallowed by the player character PC and a state B of being swallowable by the player character PC. In addition, the state B includes a state b1 in which if the non-player character is swallowed by the player character PC, the player character PC is increased in size, and the point is earned, and a state b2 in which if the non-player character is made to follow by the player character PC, the point is earned. It is noted that even in the state b2, the player character PC can swallow the non-player character NPC, but the player character PC would not be increased in size, and does not earn the point. If the player character PC collides against the non-player character NPC when the non-player character NPC is in the state A, the player character PC disappears (dies). The same is true for a case that a clear character NPCX to be described later is the non-active state. Then, when all of the player characters PC die, that is, the number of the rest of the player characters becomes zero, the game is over.

In addition, a non-player character NPC (hereinafter, referred to as non-player character NPCX in order to be discriminated from the non-player character NPC) for clear each stage (stage clear) exists in each stage. If the attribute of the player character PC does not satisfy a predetermined condition, the non-player character (hereinafter, referred to as “clear character”) NPCX for stage clear is a player-character-PC-not-followable state (non-active state). If the attribute of the player character PC satisfies the predetermined condition, the player-character-PC-followable state (active state) stands. Thus, when the player character PC makes the clear character NPCX follow itself, the stage clear (game clear) is attained.

It is noted that in this embodiment when the clear character NPCX makes the player character PC follow itself, the stage clear is attained, but it is need not to be limited thereto. It may be possible that the stage clear is attained when the player character PC swallows the clear character NPCX.

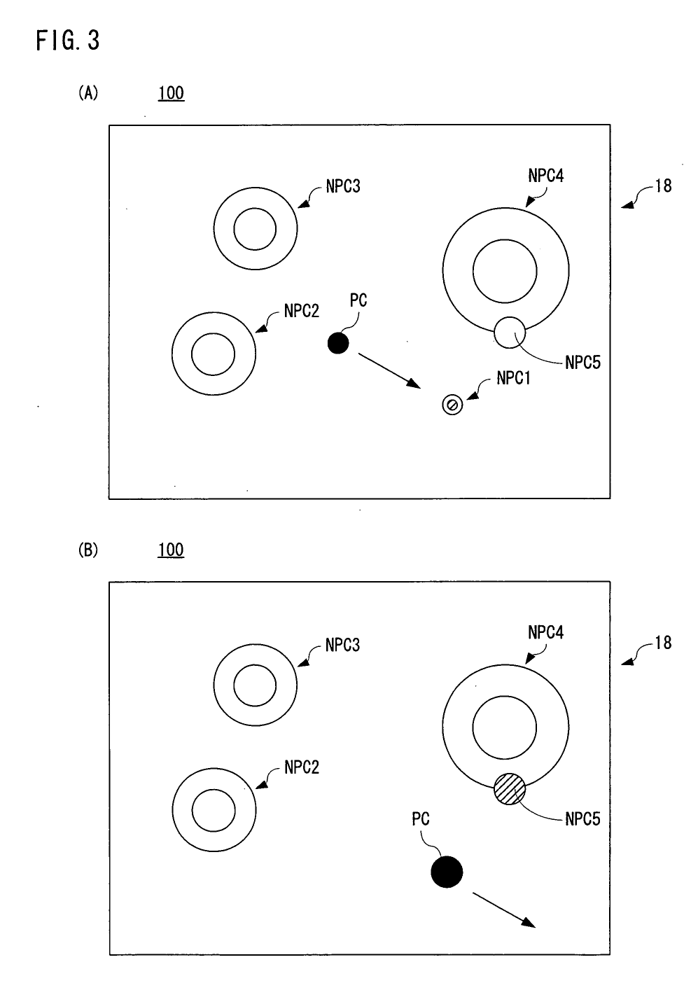

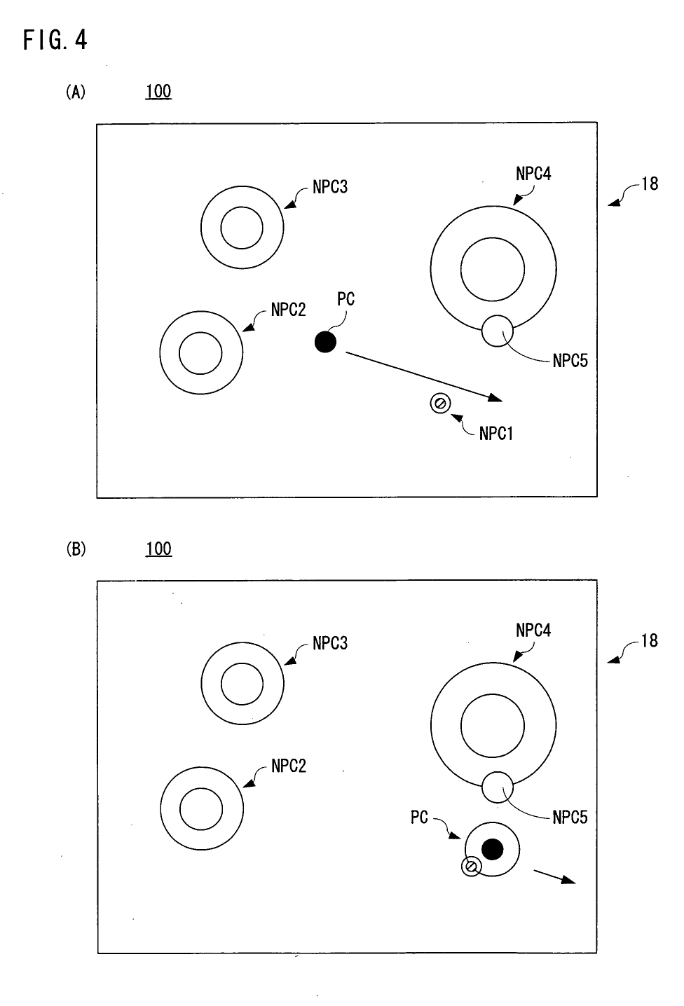

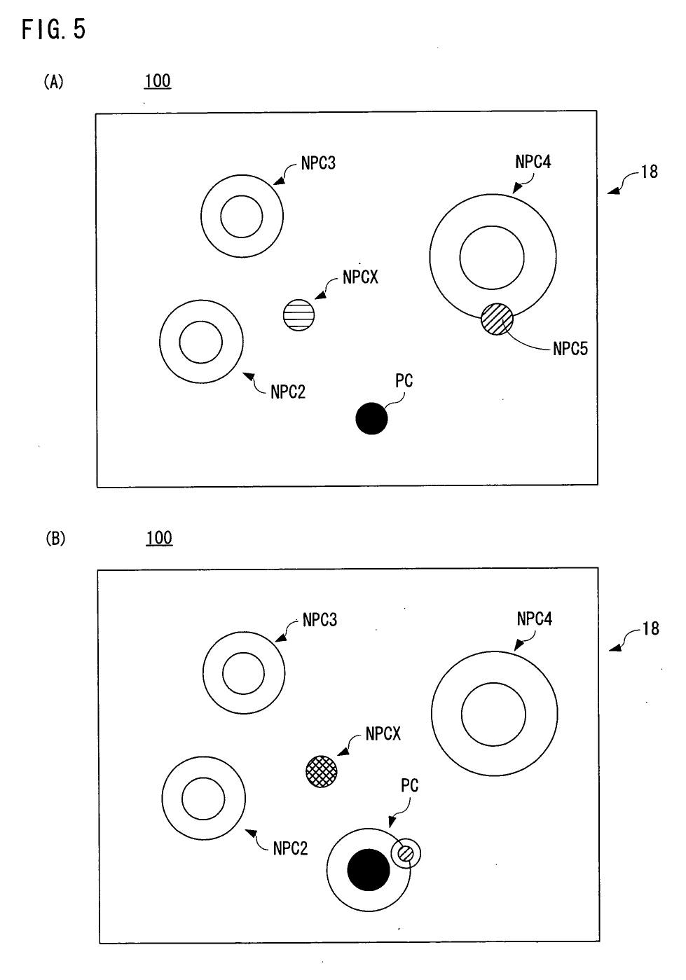

More specifically, as shown in FIG. 3(A), the LCD 18 displays a game screen 100. On the game screen 100, the player character PC is moving-displayed so as to inertially move, and the non-player character NPC (NPC1, NPC2, NPC3, NPC4, NPC5, here) is displayed in a static manner. In FIG. 3(A) (hereafter, the same is true for FIG. 3(B), FIG. 4(A), FIG. 4(B), FIG. 5(A), and FIG. 5(B)), the non-player character NPC in the state A is plain, and the non-player character NPC in the state B is diagonally shaded. On the actual game screen 100, both of them are discriminated by changing their color, etc.

It is noted that although in FIG. 3 and the following, the state b1 and the state b2 are not especially discriminated from each other, both of them are discriminated by changing their color on the actual game screen 100, etc.

As shown in FIG. 3(A), when the player character PC moves to a direction indicated by the arrow, and collides against the non-player character in the state b1, the non-player character NPC 1 is swallowed by the player character PC as shown in FIG. 3(B). Here, the player character PC is increased in size, and the non-player character NPC 1 disappears from game screen 100. For example, if the player character PC is increased in size, it is increased by the size of the swallowed non-player character NPC.

In addition, when the player character PC is increased in size, that is, when the attribute is changed, the attribute of the non-player character NPC is changed so as to become smaller than the player character PC. For example, as shown in FIG. 3(B), the non-player character NPC 5 smaller than the player character PC is changed to the state B. Here, for example, the number of the non-player characters NPC that can be changed to the state b1 out of the plurality of the non-player characters NPC is limited in each stage, and therefore, in changing to the state B, if the number of the non-player characters in the state b1 does not satisfy the limited value, the state b1 is set, and the state b2 is set otherwise.

Alternatively, as shown in FIG. 4(A), when the player character PC moves to the direction indicated by the arrow, is close to the non-player character NPC 1 in the state b2, the non-player character NPC 1 is made to follow as a part of the player character PC. In such a case, the player character PC is not changed in size, and therefore, the attributes of the non-player characters NPC 2-5 are not changed.

It is noted that, although illustration is omitted, the non-player character NPC in the state b2 is also swallowable by the player character PC as described above. Accordingly, in order to earn points not by swallowing the non-player character NPC 1 in the state b2 but making the non-player character NPC1 follow itself, for example, the player character PC needs to be close to the non-player character NPC 1 so as to be brought into contact with an outer circle of the player character PC shown in FIG. 4(B).

In addition, as shown in FIG. 5(A), in each stage, a specific non-player character NPC (clear character NPCX) exists, but the clear character NPCX exists in a non-active state incapable of making the non-player character NPC follow the player character PC until the attribute of the player character PC satisfies a predetermined condition. In FIG. 5(A), the clear character NPCX is applied with a striped pattern in order to indicate the non-active state. It is noted that in this embodiment, the predetermined condition means that the player character PC develops into a constant size or more. It is noted that it needs not to be limited thereto, and the player character PC has a defined size or more, and the number of the non-player characters to be made to follow is a predetermined value or more. Also, it is appropriate that under certain circumstances, only the number of the non-player characters player character PC to be made to follow is equal to or more than the predetermined number irrespective of the size. Such the predetermined condition is an item arbitrarily determined by a game programmer or a developer, and can be changed for each stage.

Accordingly, in FIG. 5(A) case (in FIG. 3(B) state, for example), when the player character PC swallows the non-player character NPC 5, and reaches a constant size or more, that is, when the player character PC satisfies the predetermined condition, the state is shifted to the active state which capable of making the clear character NPCX follow the player character PC as shown in FIG. 5(B). That is, the attribute of the clear character NPCX is changed. It is noted that the clear character NPCX is crosshatched in order to indicate the active state in FIG. 5(B).

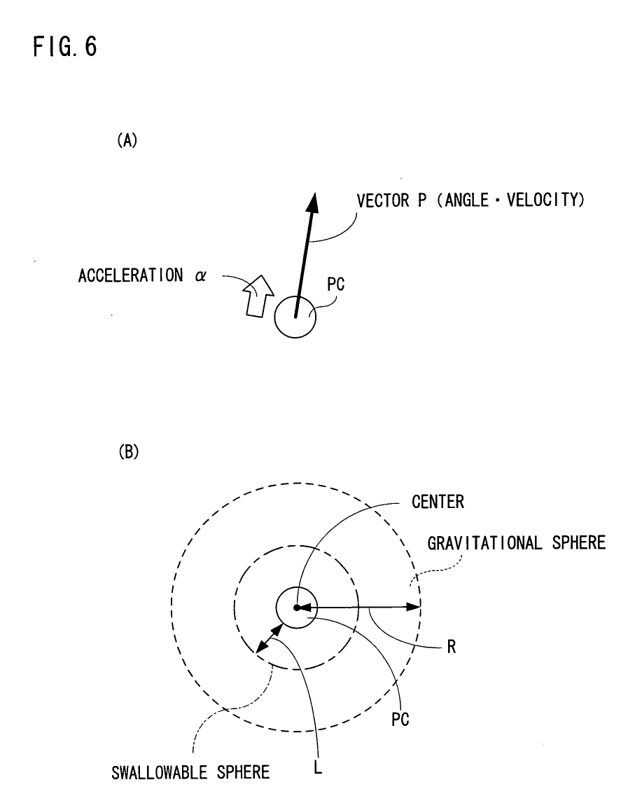

Next, a description is made on properties of the player character PC by utilizing FIG. 6-FIG. 9. As shown in FIG. 6(A), the player character PC inertially moves toward the moving vector P (angle·velocity). Therefore, only when the player operates the A button 26 and the B button 28, the player character PC works as the source of attraction and the source of repulsion; otherwise continues to move at an angle (moving direction) and velocity indicated by the moving vector P. In other words, the player character PC intertially moves at a constant acceleration α. It is noted that at a start of the game, the player character PC moves from a preset position at a preset moving vector P. It is noted that the game may be started in some stages in a state that the player character PC makes the non-player character NPC follow itself.

Here, the angle of the moving vector P is formed by the X axis where a horizontal axis of the game screen 100 (LCD 18) is the X axis and a vertical axis of the game screen 100 is the Y axis. Also, in this embodiment, the right direction of the game screen 100 is a plus direction of the X axis, and the upper direction of the game screen 100 is a plus direction of the Y axis.

If the player operates the A button 26 or the B button 28, gravity occurs over a range shown by a constant distance R as shown in FIG. 6(B). That is, when the A button 26 or the B button 28 is operated, gravity occurs within a circle with a radius of a constant distance R centered on the player character PC (gravitational sphere). If the non-player character NPC exists within the gravitational sphere, a process of gravity, that is, a moving vector P (acceleration α) calculating process is executed in response to an attractive force or a repulsive force of the non-player character NPC.

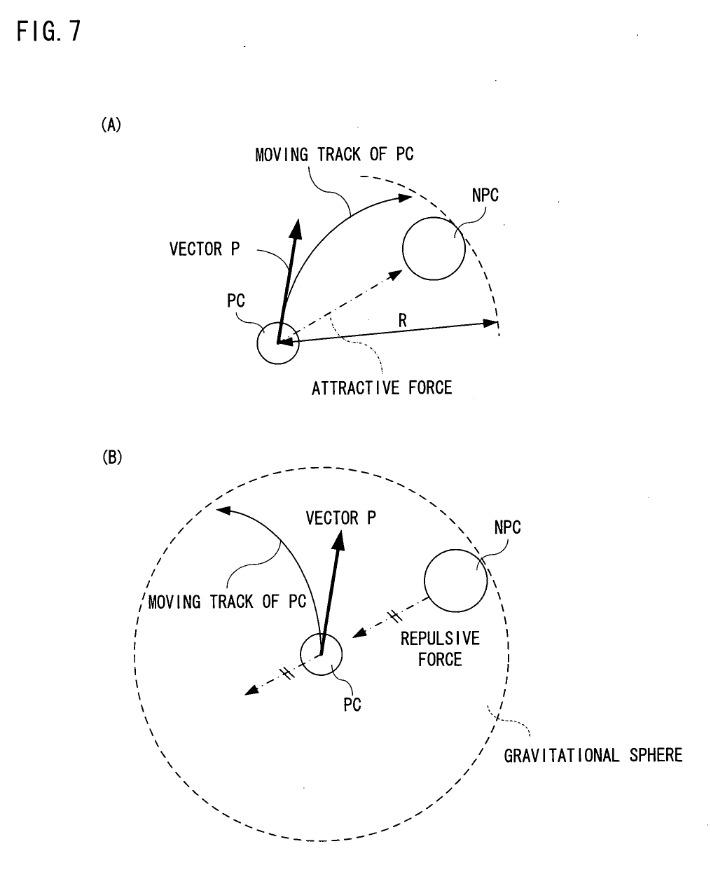

More specifically, when the A button 26 is operated, if the non-player character NPC exists within the gravitational sphere with a radius of the constant distance R, the attractive force of the non-player character NPC acts on the player character PC as shown in FIG. 7(A). Thus, the acceleration α (direction and dimension of the moving vector P) is changed by the attractive force, and the player character PC is attracted on an illustrated track in a direction (position) where the non-player character NPC exists. At this time, the player character PC moves in a direction between the direction of the moving vector P and the direction of the attractive force. It is noted that since a description on a calculation method of the acceleration a will be made later, a detailed description is omitted here.

Alternatively, when the B button 28 is operated, if the non-player character NPC exists within a circle with a radius of a constant distance R, the repulsive force of the non-player character NPC works on the player character PC as shown in FIG. 7(B). The acceleration a (direction and dimension of the moving vector P) is changed by the repulsive force, and the player character PC is made away on an illustrated track in a direction reverse to the direction where the non-player character NPC exists. At this time, the player character PC moves in a direction between the direction of the moving vector P and the direction of the repulsive force. It is noted that a calculation method of the acceleration a will be described later.

It is noted that the player character PC can swallow the non-player character NPC in the state B and make the non-player character NPC in the state B follow itself as described above, and in order to determine whether or not the player character PC swallows the non-player character NPC (or makes the non-player character NPC follow itself), a constant distance L (shorter than the constant distance R) is set as shown in FIG. 6(B). It is noted that as understood from FIG. 6(B), the constant distance L is a distance from the circumference of the player character PC. If the player character PC is close to the non-player character NPC in the state B across the constant distance L, the player character PC can swallow the non-player character NPC, and make the non-player character follow itself.

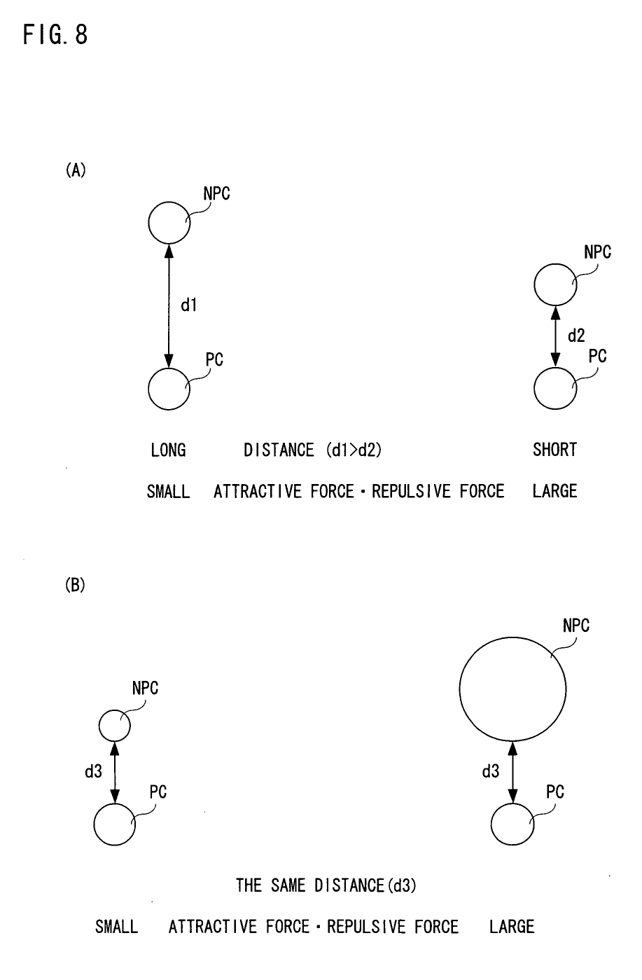

Furthermore, the attractive force and the repulsive force are changed in intensity according to the distance between the player character PC and the non-player character NPC. As shown in FIG. 8(A), if the distance between the player character PC and the non-player character NPC is short, the attractive force and the repulsive force increase. The attractive force and the repulsive force may be changed so as to linearly decrease or gradually decrease inversely proportional to the length of the distance. As shown in FIG. 8(A), in this embodiment, the distance between the player character PC and the non-player character NPC is a linear (shortest) distance connecting the respective circumferences (surface) of the circles. More specifically, this can be evaluated by subtracting sum of the radiuses of the both circles from the distance between the coordinates of the center of the respective circles.

Alternatively, the attractive force and the repulsive force are changed in intensity according to the size of the non-player character NPC. As shown in FIG. 8(B), if the distances between the player character PC and the non-player character NPC are the same, as the size (radius) of the non-player character NPC is increased, the attractive force and the repulsive force are increased. The attractive force and the repulsive force may be changed so as to linearly increase or gradually increase in proportion to the length of the radius.

It is noted that, as shown in FIG. 8(A) and FIG. 8(B), the intensity of the attractive force and the repulsive force are changed depending on two elements (factors), that is, the distance between the player character PC and the non-player character NPC, and the size of the non-player character NPC.

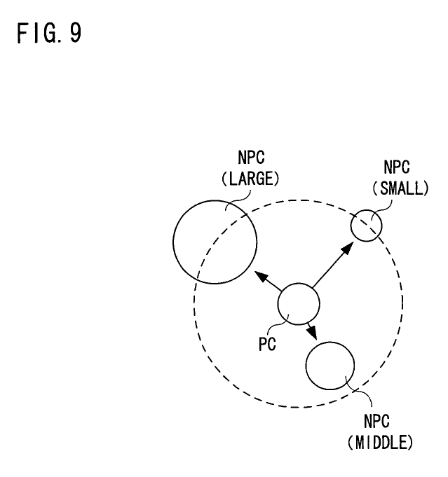

In addition, as shown in FIG. 9, if a plurality of (three, here) non-player characters NPC exist within the gravitational sphere shown in FIG. 6(B), each of the attractive force and the repulsive force working between the player character PC and each non-player characters NPC is calculated, and the moving vector P according to the attractive force and the repulsive force provided by all the non-player characters NPC is calculated.

A description is made on a detailed calculation method of the moving vector P (acceleration α). Noted that if gravity does not occur with respect to the player character PC, the attractive force or the repulsive force does not work, and therefore, only when the A button 26 or the B button 28 is operated, a calculation process of the moving vector P is executed. A presence or absence of the button operation is detected for every constant time (1 frame: screen update per unit of time ( 1/60 seconds)), and thus, the moving vector P is calculated for each frame in a state that the A button 26 or the B button 28 is turned on. It is noted that if the non-player character NPC does not exist at all within the gravitational sphere, the attractive force and the repulsive force do not work, and therefore, the calculation process of the moving vector P is not executed in this case also.

First, when gravity g (−1.0-+1.0, here) occurs on the player character PC, all the non-player characters NPC existing within the range of the gravity g (gravitational sphere) is listed. Then, a following calculation process is executed with respect to each of the non-player characters NPC. It is noted that positive and negative signs of the gravity g allow the discrimination between the attractive force and the repulsive force in this embodiment.

(1) The vector q from the center of the player character PC to the non-player character NPC is obtained, and normalized. Here, the vector q can be easily obtained by making the center of the player character PC a starting point, and making the center of the non-player character NPC an endpoint.

(2) The decree of influence e by the distance d between the player character PC and the non-player character NPC is calculated according to Equation 1. It is noted that the constant distance (gravitational sphere) influenced by the gravity g shall be R as described above.
e=1.0−d/R [Equation 1]

(3) Next, a ratio between the size of the player character PC and the size of the non-player character NPC is normalized. More specifically, according to Equation 2, the size of the player character PC and the size of the non-player character NPC are normalized. It is noted that in Equation 2, the size of the normalized player character PC shall be pcmass, the size of the normalized non-player character NPC shall be npcmass, the size of the player character PC shall be pc, and the size of the non-player character NPC shall be npc. Here, the sum of the size of the player character PC and the size of the non-player character NPC shall be 1.0.
pcmass=pc×norm
npcmass=npc×norm
norm=1.0/(pc+npc) [Equation 2]

(4) Then, the acceleration a applied from the non-player character NPC to the player character PC is obtained by multiplying the vector q toward the non-player character NPC by the degree of influence e according to the distance, the size of the normalized player character PC pcmass, and the gravity g of the current player character PC. That is, the acceleration a is evaluated according to Equation 3.
a=q×e×pcmass×g [Equation 3]

Although a detailed description is omitted, accelerations a (a 1, a 2, a 3, . . . , for example) of the respective of the listed non-player characters NPC to be provided to the player character PC are combined so as to be combined with the current acceleration α of the player character PC.

FIG. 10 shows an illustrative view of a memory map of the ROM 60. The ROM 60 includes a game program storage area 602 and a data storage area 604. The game program storage area 602 stores a game program. The game program comprises a game main processing program 602a, an image generating program 602b, a PC movably display controlling program 602c, an NPC display controlling program 602d, an operation input detecting program 602e, a movement vector calculating program 602f, an NPC swallowing/following processing program 602g, an attribute updating program 602h, etc.

The game main processing program 602a is a program for processing a main routine of a virtual game. The image generating program 602b is a program for generating a background image and a character image such as a player character PC, a non-player character NPC, an item character, and the like by utilizing character image data 604a (484a, 486a, . . . ) and game map data 604b (482c) described later. The image generating program 602b changes the size and the color (texture) depending on the change of the attribute of the player character PC, the non-player character NPC, and the clear character NPCX. It is noted that the shape is also changeable. The PC movably display controlling program 602c is a program for movably displaying on the LCD 18 an image of the player character PC generated by the image generating program 602b according to the moving vector P. The NPC display controlling program 602d is a program for displaying images of the non-player character NPC and the clear character NPCX generated by the image generating program 602b on the LCD 18.

The operation input detecting program 602e is a program for detecting an operation signal (operation data) input from the operation switch 56 at every constant time (one frame), and storing (temporarily storing) it into the WRAM 48 to be described later. The movement vector calculating program 602f is a program for calculating the moving vector P (acceleration a) of the player character PC when the operation data of the A button 26 or the B button 28 is detected by the operation input detecting program 602e. The NPC swallowing/following processing program 602g is a program for changing (updating) the image (image data 484a described later) and the attribute (attribute data 484c described later) of the player character PC in order to make the player character PC swallow the non-player character NPC, and make the non-player character NPC follow the player character PC itself. The attribute updating program 602h is a program for changing (updating) the attribute (attribute data 486c described later, etc.) of the non-player character NPC and the clear character NPCX when the attribute of the player character PC (size) changes.

It is noted that, although illustration is omitted, in the program storage area 602, a game sound reproduction program, a backup program, etc. are stored. The game sound reproduction program outputs from the speaker 36 a sound required for game such as a voice (sound) of the characters, sound effect, BGM, etc. by utilizing sound data 604c described later. The backup program is a program for storing (saving) the game data (proceeding data, result data) generated according to a predetermined event and a predetermined operation during the game in the RAM 62 of the game cartridge 14.

In the data storage area 604, character image data 604a, entire game map data 604b, sound data 604c, etc. are stored. The character image data 604a is image data (polygon data, texture data, etc.) of the characters (player character PC, non-player character NPC, clear character NPCX, etc.) appearing in the virtual game. The entire game map data 604b is game map data in each stage prepared in the virtual game, and each game map is spherically formed in this embodiment. The sound data 604c is data for generating and outputting a sound required for the game.

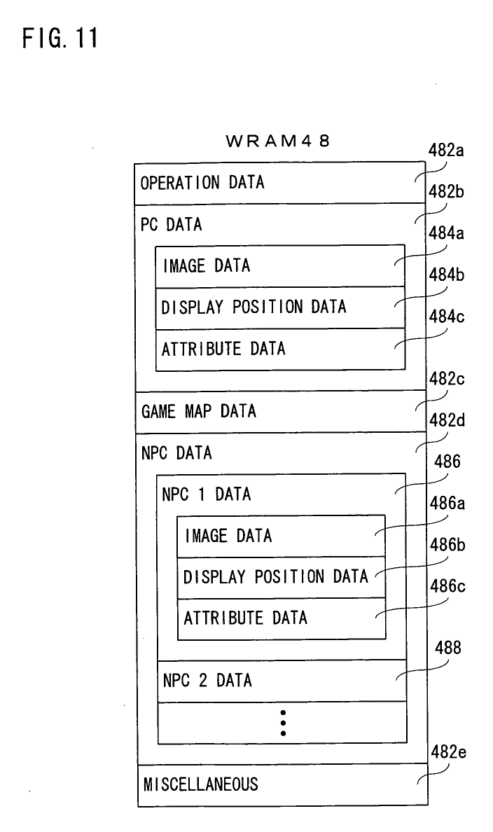

Also, FIG. 11 shows one example of a memory map of the WRAM 48. Referring to FIG. 11, the WRAM 48 stores operation data 482a, PC data 482b, game map data 482c, NPC data 482d, etc. The operation data 482a is operation data detected and temporarily stored by the operation input detecting program 602e as described above, and is updated for every frame.

The PC data 482b is data as to the player character PC, and comprises image data 484a, display position data 484b, and attribute data 484c. The image data 484a is image data (polygon data, texture data, etc.) of the player character PC, and generated by utilizing the above-described character image data 604a. The display position data 484b is data (coordinates position data) of the display position (coordinates position) of the player character PC in the game world. That is, the coordinates position indicated by the display position data 484b indicates a current position of the player character PC on the game map. As described above, the player character PC inertially moves, and changes its moving direction depending on the attractive force and the repulsive force, and therefore, the display position data 484b is updated for each frame. The attribute data 484c is data indicative of the attribute of the player character PC. Here, the attribute of the player character PC includes the size (radius or diameter), presence or absence of the following non-player character NPC, and the number of the following non-player characters NPC.

The game map data 482b is data as to the game map. The data corresponding to each stage (or phase) is read from the above-described entire game map data 604b according to the operation (selection) by the player or selection by the computer (CPU core 42). At this time, for example, a difficulty level of the game is determined depending on the level of the player and the selection by the player, and arrangement positions of the non-player characters NPC are determined depending on the difficulty level. In addition, as described above, each game map is spherically formed. This allows the player character PC to continue to move in the same direction.

The NPC data 482d is data as to the non-player character NPC (including a clear character NPCX). As understood from FIG. 11, the NPC data 482d is stored for each non-player character NPC (for the sake of convenience, referred to be NPC 1, NPC2 . . . , here). The NPC 1 data 486 includes image data 486a, display position data 486b, and attribute data 486c. The image data 486a is image data as to the non-player character NPC 1 (polygon data, texture data, etc.), and generated by utilizing the above-described character image data 604a. The display position data 486b is data (coordinates position data) of a display position (coordinates position) of the non-player character NPC 1 in the game world. That is, the coordinates position indicated by the display position data 486b indicates a current position of the non-player character NPC 1 on the game map. The attribute data 486c is data indicative of an attribute of the non-player character NPC 1. Here, the attribute of the non-player character NPC 1 includes a size (radius or diameter), and a state A or a state B (state b1 or state b2). This holds true for other non-player characters NPC 2, . . . . It is noted that the attribute of the clear character NPCX is identification information indicative of being a clear character NPCX and state information indicative of being an active state or a non-active state.

Since this holds true for the other non-player characters NPC 2, . . . , an illustration and a detailed description will be omitted here.

In addition, the WRAM 48 is provided with a miscellaneous area 482e. The miscellaneous area 482e is utilized for storing game data (proceeding data, result data) not shown, loading the above-described program as necessary, and so forth.

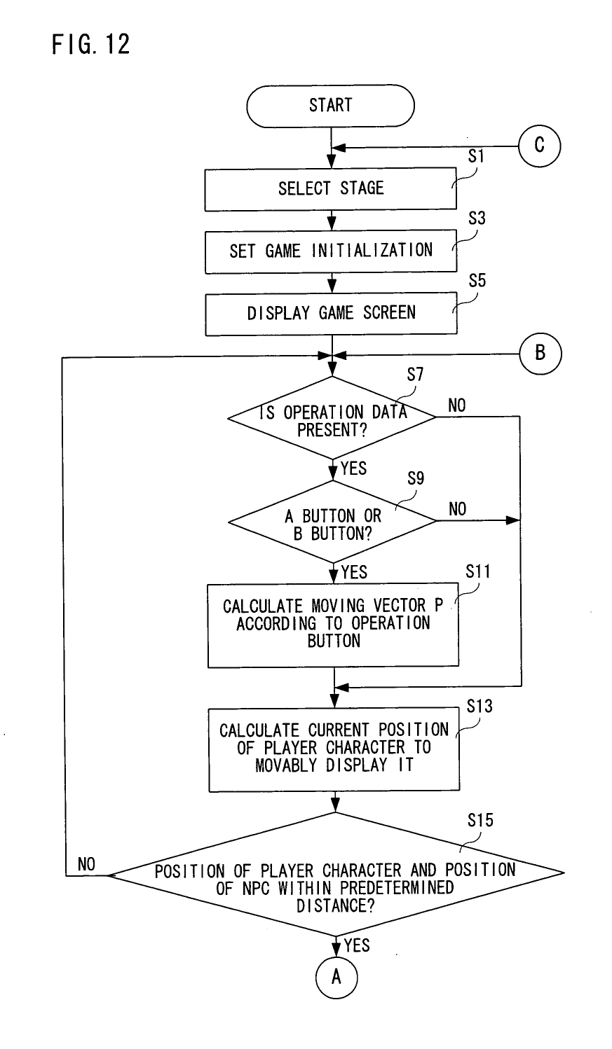

Specifically, the CPU core 42 shown in FIG. 2 executes a game process according to a flowchart shown in FIG. 12-FIG. 14. As shown in FIG. 12, when starting a game process, the CPU core 42 executes a stage selection process in a step S1. Here, a stage (phase) is selected according to an instruction from the player, or automatically selected. In a succeeding step S3, a game initialization setting is executed. More specifically, the CPU core 42 initializes (clears) the operation data 482a, and reads the game map data 482c corresponding to the selected stage from the ROM 60 to store (write) it in the WRAM 48. Also, the CPU core 42 reads the character image data 604a from the ROM 60 to generate the image data 484a of the player character PC, sets the display position data 484b to the coordinates data indicative of an initial position, initializes the attribute data 484c, and so forth. In addition, the CPU core 42 reads the character image data 604a from the ROM 60 to generate image data corresponding to each non-player character NPC existing in the stage, sets the display position data 484b to the coordinates data indicative of a predetermined position, sets the attribute data, and so forth. In a next step S5, the game screen 100 is displayed on the LCD 18. Here, the initialized player character PC is moved from the initial position on the game map, and a part of the game map including the player character PC is displayed on the LCD 18. At this time, the non-player character NPC being close to or around the player character PC is statically displayed.

In a succeeding step S7, it is determined whether or not operation data is present. That is, the CPU core 42 determines whether or not operation data is input from the operation switch 56. If “NO” in the step 7, that is, if the operation data is not input, the process directly proceeds to a step S13 without calculating the moving vector P (acceleration α). Although illustration is omitted, the operation data 482a temporarily stored in the RAM 48 is erased (cleared). On the other hand, if “YES” in the step 7, that is, if the operation data is input, it is determined whether or not the A button 26 or the B button 28 is operated in a step S9. That is, it is determined whether the operation data 482a stored in the RAM 48 corresponds to the A button 26 or the B button 28. Although illustration is omitted, if “YES” in the step S7, the input operation data is stored in the RAM 48, a determination process is executed with reference to the operation data 482a stored in the RAM 48 in a step S9.

If “NO” in the step 9, that is, if the A button 26 or the B button 28 is not operated, the process directly proceeds to the step S13. That is, an operation of the buttons (20, 22, 24, 32 and 34) except for the A button 26 or the B button 28 would be neglected. It is noted that although illustration is omitted, an operation of the start button 22 allows the game to be temporarily stopped, and the game to be restarted. During the temporary stop of the game, the cross key 20 is set to accept an operation for selecting an end or a restart (continuation) of the game. On the other hand, if “YES” in the step 9, that is, if the A button 26 or the B button 28 is operated, a moving vector P (acceleration α) is calculated according to the operation button (A button 26, B button 28) in a step S11, and then, the process proceeds to the step S13. The calculation of the moving vector P is as described above. It is noted that even if the A button 26 or the B button 28 is operated, when the non-player character NPC does not exists at all within the gravitational sphere (within the constant distance R), the calculation process of the moving vector P is not executed.

In the step S13, a current position of the player character PC is calculated to movably display the player character PC on the game screen 100. That is, the player character PC is movably displayed. As described above, if the moving vector P (acceleration α) is not calculated, a position obtained from moving by one frame of distance is calculated as a current position without changing the moving direction and velocity indicated by the moving vector P. It is noted that if the moving vector P (acceleration α) is calculated in the step S11, a position obtained from moving by one frame of distance at the moving direction and velocity indicated by the moving vector P is calculated as a current position.

In a succeeding step S15, it is determined whether or not the position of the player character PC and the position of the non-player character NPC are within the constant distance L. Here, the CPU core 42, with reference to the RAM 48, fetches a display position and a size of the player character PC, and fetches a display position and a size of each non-player character NPC to determine whether or not the distance between the player character PC and each of the non-player character NPC is within the constant distance L. That is, it is determined whether or not each non-player character is within a sphere swallowable by the player character PC.

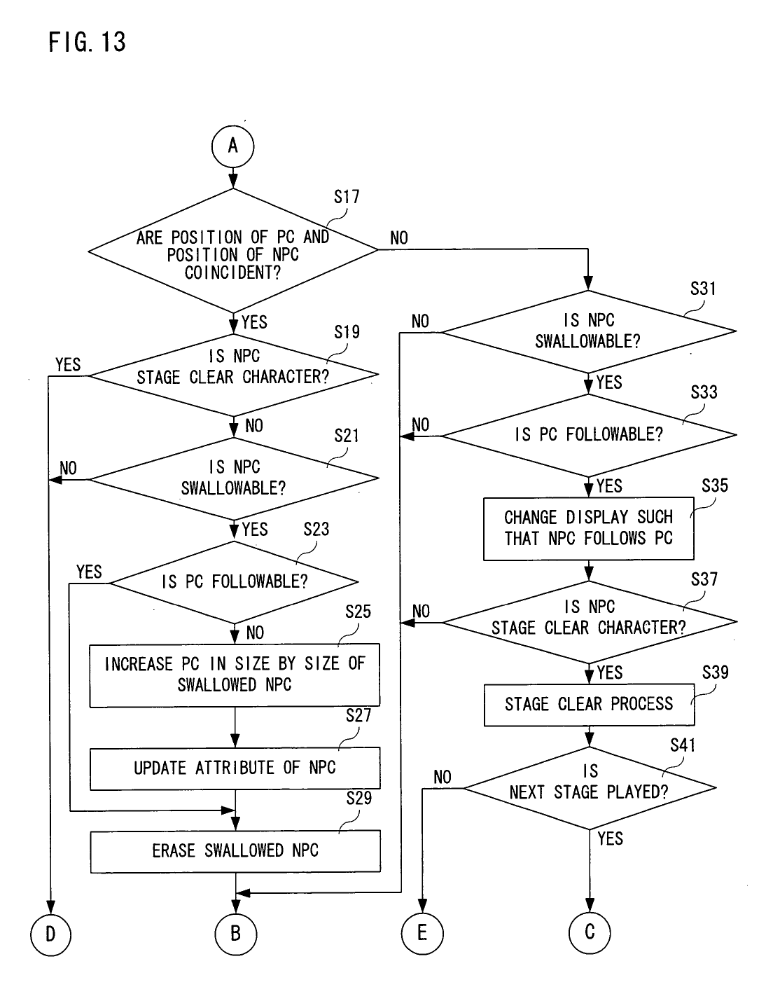

If “NO” in the step 15, that is, if the position of the player character PC and the position of the non-player character NPC are out of the constant distance L, the process directly returns to the step S7. On the other hand, if “YES” in the step 15, that is, if the position of the player character PC and the position of the non-player character NPC are within the constant distance L, it is determined whether or not the position of the player character PC and the position of the non-player character NPC are coincident with each other in a step S17 as shown in FIG. 13. Strictly, determination whether or not the player character PC contacts the non-player character NPC requires to determine whether or not the distance between the center of the circle of the player character PC and the center of the circle of the non-player character NPC is shorter than the length obtained from the sum of the respective radiuses.

If “YES” in the step 17, that is, if the position of the player character PC and the position of the non-player character NPC are coincident with each other, it is determined whether or not the non-player character NPC is a clear character NPCX in a step S19. Here, with reference to the attribute data of the non-player character data (486c, etc.), it is determined whether or not the identification information of the clear character NPCX is included.

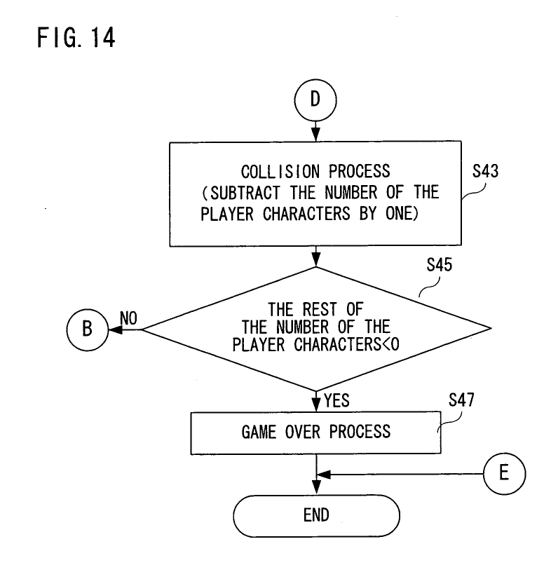

If “YES” in the step 19, that is, if the non-player character NPC is a clear character NPCX, the process proceeds to a step S43 shown in FIG. 14. On the other hand, If “NO” in the step 19, that is, if the non-player character NPC is not a clear character NPCX, it is determined whether or not the non-player character NPC is swallowable in a step S21. More specifically, with reference to the attribute data (486c, e.g.) of the non player object NPC, it is determined whether or not the non-player character NPC is in the state B capable of being swallowed by the player character PC.

If “NO” in the step 21, that is, if the non-player character NPC is in the state A, the process proceeds to the step S43. On the other hand, if “YES” in the step 21, that is, if the non-player character NPC is in the state B, it is determined whether or not the non-player character NPC can follow the player character PC in a step S23. That is, it is determined whether or not the state b2 stands. If “YES” in the step 23, that is, if it is determined the state b2 stands, and the non-player character NPC can follow the player character PC, the process proceeds to a step S29. At this time, as described later, the non-player character NPC is erased from the game screen 100 so as to be represented as if it is swallowed by the player character PC. However, the player character PC is not increased in size, and the point is never added.

On the other hand, if “NO” in the step 23, that is, if the state b1 stands, and the player character PC can be increased in size, the player character PC is increased in size by the amount corresponding to the size of the non-player character NPC in a step S25. That is, the image data 484a and the attribute data 484c of the player character PC are updated, and the player character PC is displayed in an enlarged manner. Although illustration is omitted, the point is added at this time. In a succeeding step S27, the attribute of the non-player character is updated. More specifically, with reference to the attribute data 484c of the player character PC and the attribute data (486c, etc.) of all the non-player characters NPC, the sizes of the respective characters are compared with the size of the player character PC, and a non-player character NPC smaller than the player character PC is made to become the state B (state b1 or state b2) on the basis of the comparison. At this time, as to the non-player character NPC shifting from the state A to the state B, the image data (486a, etc.) and the attribute data (486c, etc.) are updated to thereby change the color (or pattern) of the non-player character NPC displayed on the game screen 100, informing the player of the attribute change. If the attribute of the player character PC satisfies the predetermined condition, the attribute of the clear character NPCX is changed in the step S27, and the active state capable of making the clear character follow the player character PC stands. Then, in the step S29, the swallowed non-player character NPC is erased from the game screen 100, and the process returns to the step S7 shown in FIG. 12. For example, the CPU core 42 erases the NPC data (486, 488, . . . , etc.) as to the non-player character NPC from the RAM 48.

If “NO” in the step 17, that is, if the position of the PC and the position of the NPC are not coincident with each other, it is determined whether or not the non-player character NPC is in a state B capable of being swallowed by the player character PC in a step S31. Since the determination method is described as in the step S21, a duplicated description is omitted here. If “NO” in the step 31, the process directly returns to the step S7. On the other hand, if “YES” in the step 31, it is determined whether or not the non-player character NPC can follow the player character PC in a step S33. Since the determination method is described as in the step S23, a duplicated description is omitted here. If the non-player character NPC is a clear character NPCX, it is also determined whether or not the attribute is in the active state capable of being made to follow the player character PC.

If “NO” in the step 33, the process directly returns to the step S7. On the other hand, if “YES” in the step 33, a display is changed such that the non-player character NPC follows the player character PC. That is, the image data 484a and the attribute data 484c of the player character PC are updated, and the player character PC including the non-player character NPC is displayed. Although illustration is omitted, the point is added at this time.

Succeedingly, it is determined whether or not the following non-player character NPC is a clear character NPCX in a step S37. If “NO” in the step 37, that is, if the following non-player character NPC is not a clear character NPCX, the process directly returns to the step S7. On the other hand, if “YES” in the step 37, that is, if the following non-player character NPC is a clear character NPCX, a stage clear process is executed in a step S39. For example, in the step S39, a message indicative of the clear of the stage is displayed, a music (sound) is output, or the combination thereof is executed. Also, a selection screen (not illustrated) for determining whether or not a next stage is played is displayed.

Then, in a step S41, it is determined whether or not the next stage is played. If “NO” in the step 41, that is, if the next stage is not played (“NO”) is selected on the selection screen, the game processing is ended as shown in FIG. 14. However, if “YES” in the step 41, that is, if the next stage is played (“YES”) is selected on the selection screen, the process returns to the step S1 shown in FIG. 12 to play the game of the next stage.

As shown in FIG. 14, a collision process is executed in the step S43. In this embodiment, a game screen 100 is displayed showing that the player character PC collides the non-player character NPC incapable of being swallowed by the player character PC or following the player character PC (including the clear character NPCX in the non-active state), and disappears (dies). At this time, the rest of the number of the player characters PC is subtracted by 1, and the PC data 482b is initialized. It is noted that although the illustration is omitted in FIG. 11, numerical value data indicative of the rest of the number of the player characters PC is stored in the miscellaneous area 482e of the WRAM 48. Then, in a step S45, it is determined whether or not the rest of the number of the player characters PC is less than 0. If “NO” in the step 45, that is, if the rest of the number of the player characters PC is equal to or more than 1, the process returns to the step S7 shown in FIG. 12. However, If “YES” in the step 45, that is, if the rest of the number of the player characters PC is less than 0, a game over process is executed in a step S47 to end the game process. For example, in the step S47, a message indicative of the game over is displayed, a music (sound) is output, or the combination thereof is executed.

It is noted that a scan time of the game process shown in FIG. 12 to FIG. 14 is one frame. Therefore, the attribute of the player character PC and the non-player character are changed for each frame, and the moving vector P of the player character PC is changed.

According to this embodiment, by operating the different buttons, an attractive force and a repulsive force can be applied to the player character, and this allows the player character to provide a more complicated movement than a case that any one of the forces is applied. That is, it is possible for the player to feel a new sense of operating.

It is noted that, although the present invention is applied to the hand-held type game machine in this embodiment, it can be applied to various kinds of game machines, such as game consoles.

Also, in this embodiment, when the gravity g acts on the player character PC, the accelerations a of the respective non-player characters NPC existing within the gravitational sphere to be applied to the player character PC are calculated, and all the accelerations a and a current acceleration of the player character PC are combined with each other to change the moving vector P of the player character PC. However, it is not limited to the method, and another method is applicable.

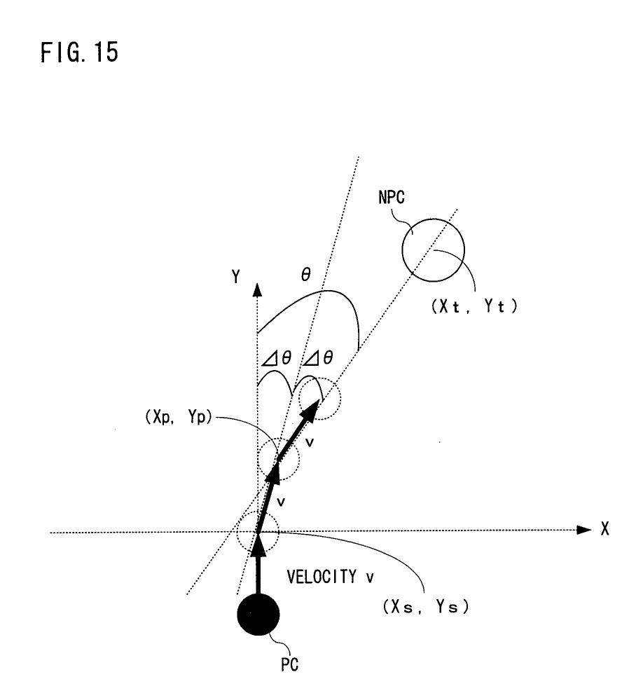

For example, as shown in FIG. 15, if the velocity v of the player character PC is made constant, a moving direction of the player character PC can be changed on the basis of the angle θ formed by a moving direction (direction of the velocity v) of the player character PC at a start of calculating the moving character (at first) and a moving direction from a current position of the player character PC to the position of the non-player character NPC. In FIG. 15, the player character PC existing at the start position is blacked out. Now, the player character PC shall exist at the point indicated by the coordinates (Xp, Yp). Also, in FIG. 15, the X-Y axes are represented by regarding a moving direction of the moving at a constant velocity player character PC (at a start) as a Y axis, and these are different from the axes of the absolute coordinate in the game space.

As shown in FIG. 15, the angle θ is evaluated (roughly calculated) according to Equation 4. It is noted that the current position of the player character PC is the coordinates (Xp, Yp), and the position of the non-player character NPC is the coordinates (Xt, Yt).
≈θ0 tan⁻¹ {(Xt−Xp)/(Yt−Yp)} [Equation 4]

Assuming that the angle θ is the total of the angles Δθ, it is appropriate that the moving direction of the velocity v is changed by Δθ every time that the A button 26 is 20 operated. Therefore, in a case that the player character PC is moved to the current position, each component of the coordinates (Xp, Yp) of the current position is calculated by utilizing each component of the coordinates (Xs, Ys) of the previous (one-frame before) position of the player character PC according to Equation 5.

Xp=Xs+v sinΔθ
Yp=Ys+v cosΔθ [Equation 5]

Altouhg a detailed description will be omitted, it is noted that if a repulsive force works, the arithmetic operation utilizing the angle Δθ is executed such that the coordinates of the current position moves to a direction reverse to the attractive force, that is, in the left direction of the X axis shown in FIG. 15. That is, if the repulsive force works, an arithmetic operation when an attractive force works is performed, and then, the coordinates is merely transformed with respect to the Y axis.

If a plurality of non-player characters NPC exist, coordinates are calculated with respect to each of the non-player characters NPC to evaluate the average of all the evaluated coordinates as described above.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A storage medium storing game program game of a game apparatus provided with an operation means, a storage means, and a display means,
said game program causes a processor of said game apparatus to execute following steps of:
a operation input detecting step for detecting at least first operation data and second operation data different from the first operation data to be input in response to an operation of said operation means;
a player character movement display step for movably displaying on said display means a player character inertially moving on the basis of said operation data and player character data stored by said storage means;
a non-player character display step for displaying a non-player character on said display means on the basis of the non-player character data which is stored in said storage means and is plural in number, and to which a different attribute is set;
a first moving direction calculating step for calculating a first direction in which said player character moves in association with said non-player character by making said player character work as the source of attraction according to said first operation data;
a second moving direction calculating step for calculating a second direction reverse to said first direction in which said player character moves in association with said non-player character by making said player character work as the source of repulsion according to said second operation data, and
a player character moving step for moving said player character to the first direction calculated by said first moving direction calculating step or the second direction calculated by said second moving direction calculating step.

2. A storage medium storing game program according to claim 1, wherein
said game program, when said player character and any one of said non-player characters have a predetermined positional relationship, and a first attribute of the player character and a second attribute of the non-player character have a predetermined condition, causes the processor to execute a first attribute updating step for updating said first attribute.

3. A storage medium storing game program according to claim 2, wherein
said game program causes the processor to execute a second attribute updating step for updating said second attribute according to the first attribute updated by said first attribute updating step.

4. A storage medium storing game program according to claim 2, wherein
said first attribute includes at least a size of said player character,
said second attribute includes at least a size of said non-player character,
said first attribute updating step updates said first attribute such that said player character is increased in size when said player character is larger than said non-player character which has a predetermined positional relationship with said player character.

5. A storage medium storing game program according to claim 4, wherein
said game program causes the processor to further execute a non-player character disappearance step for making said non-player character having the predetermined positional relationship with said player character disappear when said first attribute updating step increase said player character in size.

6. A storage medium storing game program according to claim 4, wherein
said game program causes the processor to further execute a player character disappearance step for making said player character disappear when said player character is smaller than said non-player character which has the predetermined positional relationship with said player character.

7. A storage medium storing game program according to claim 2, wherein
said game program causes the processor to further execute a game clear determination step for determining to be a game clear when said second attribute of said non-player character having a predetermined positional relationship with said player character indicates a specific property.

8. A storage medium storing game program according to claim 1, wherein
said first direction calculating step calculates a moving direction of the player character such that the moving direction of said player character is gradually converged into a first direction toward a position of any one of said non-player characters, and
said second direction calculating step calculates a moving direction of the player character such that said moving direction of said player character is gradually converged into a second direction away from a position of any one of said non-player characters.

9. A game apparatus provided with an operation means, a storage means, and a display means, comprising:
a operation input detecting means for detecting at least first operation data and second operation data different from the first operation data to be input in response to an operation of said operation means;
a player character movement display means for movably displaying on said display means a player character inertially moving on the basis of said operation data and player character data stored by said storage means;
a non-player character display means for displaying a non-player character on said display means on the basis of non-player character data which is stored in said storage means and is plural in number, and to which a different attribute is set;
a first moving direction calculating means for calculating a first direction in which said player character moves in association with said non-player character by making said player character work as the source of attraction according to said first operation data;
a second moving direction calculating means for calculating a second direction reverse to said first direction in which said player character moves in association with said non-player character by making said player character work as the source of repulsion according to said second operation data; and
a player character moving means for moving said player character to the first direction calculated by said first moving direction calculating means or the second direction calculated by said second moving direction calculating means.

10. A game controlling method of a game apparatus provided with an operation means, a storage means, and a display means, comprising following steps of:
(a) detecting at least first operation data and second operation data different from the first operation data to be input in response to an operation of said operation means,
(b) movably displaying on said display means a player character inertially moving on the basis of said operation data and player character data stored by said storage means,
(c) displaying a non-player character on said display means on the basis of non-player character data which is stored in said storage means and is plural in number, and to which a different attribute is set,
(d) calculating a first direction in which said player character moves in association with said non-player character by making said player character work as the source of attraction according to said first operation data,
(e) calculating a second direction reverse to said first direction in which said player character moves in association with said non-player character by making said player character work as the source of repulsion according to said second operation data, and
(f) moving said player character to the first direction calculated by said step (d) or the second direction calculated by said step (e).
